(19) United States
(12) Patent Application Publication
(10) Pub. No.: US 2020/0379747 A1
(43) Pub. Date: Dec. 3, 2020

(54) SOFTWARE UPDATE MECHANISM

(71) Applicants: Arm IP Limited, Cambridge (GB); Arm Limited, Cambridge (GB)

(72) Inventors: Mika Jere Petteri Kaartinen, Oulu (FI); Brendan James Moran, Histon (GB)

(21) Appl. No.: 16/884,847

(22) Filed: May 27, 2020

(30) Foreign Application Priority Data
May 28, 2019 (GB) 1907498.8

(51) Int. Cl. G06F 8/65; G06F 21/44

(52) U.S. Cl. CPC G06F 8/65; G06F 21/44

(57) ABSTRACT

Provided is a technology including an apparatus and a machine-implemented method for updating software on a device, the method performed at the device comprising: receiving a software update manifest comprising an authenticated resource request identifier and an authenticated definition identifying one or more characteristics of the device; generating a software update request comprising a value for each of the one or more identified characteristics of the device; transmitting, to a location corresponding to the resource request identifier, the built software update request; receiving a resource enabling access to or including a software update appropriate for the one or more values of the one or more identified characteristics; and updating the software of the device in accordance with the software update.

### RELATED APPLICATION

The present application claims priority to Application No. GB 1907498.8 filed May 28, 2019, which is hereby incorporated herein in its entirety by reference.

The present technology is directed to distribution of software to electronic devices over a network.

In the past, information processing environments were typically isolated from the “real world”, secured from interference by physical barriers and lack of electronic connections, and under the control of dedicated professionals with detailed knowledge of system operation, data integrity and system security. Such installations were once kept behind locked doors and tended by trained operators and system programmers; they were often only accessible from dedicated terminal devices which were themselves often kept in secure areas of a plant or office. Updates to data content were usually conducted by selected professionals whose interactions with the systems were filtered through access control lists and passwords, and were often subject to checks and balances such as “buddy-checking”, managerial sign-offs, and sometimes long periods of testing and parallel operation to ensure that the correct and secure functioning of the systems was maintained.

In recent years, by contrast, more and more devices are becoming networked and provided with local processing capability; these devices typically, but not exclusively, operate in unprotected environments, open to the world through Internet connections, and under the control of people without any particular training in system operation, integrity and security.

Devices from home computers to vehicles and light-bulbs have begun to acquire these additional functions and to be connected together through the Internet of Things (IoT). With this proliferation of networked devices, system security and content integrity present increasingly complex difficulties.

In a first approach there is provided a machine-implemented method for updating software on a device, the method performed at the device comprising: receiving a software update manifest comprising an authenticated resource request identifier and an authenticated definition identifying one or more characteristics of the device; generating a software update request comprising a value for each of the one or more identified characteristics of the device; transmitting, to a location corresponding to the resource request identifier, the built software update request; receiving a resource enabling access to or including a software update appropriate for the one or more values of the one or more identified characteristics; and updating the software of the device in accordance with the software update.

In a further approach there is provided a machine-implemented method for provisioning a software update on a device, the method performed at a server comprising: sending, from the server to the device, a software update manifest comprising an authenticated resource request identifier and an authenticated definition identifying one or more characteristics of the device; receiving, at the server from the device, a software update request; sending, from the server to the device, a resource based on or in response to the software update request, wherein the resource is to enable the device to access the software update or wherein the resource includes the software update.

In a further approach there is provided a machine-implemented method for provisioning a software update from a first device to a second device, the method performed at the first device comprising: receiving, at the first device, a software update request generated by a second device and destined for a server; parsing, at the first device, the software update request; sending, from the first device to the second device, a resource based on or in response to the software update request when the resource is available, wherein the resource is to enable the device to access the software update or wherein the resource includes the software update; or forwarding, from the first device to the server, the software update request when the resource is not available to the second device.

In a hardware approach, there is provided electronic apparatus comprising logic elements operable to implement the methods of the present technology. In another approach, the computer-implemented method may be realized in the form of a computer program operable to cause a computer system to perform the process of the present technology.

Implementations of the disclosed technology will now be described, by way of example only, with reference to the accompanying drawings, in which:

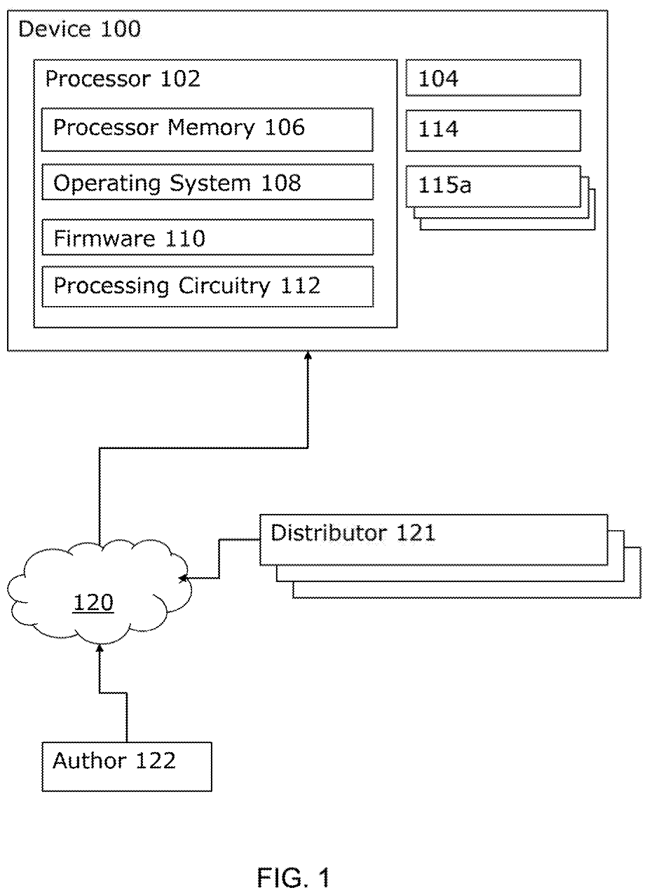

FIG. 1 shows an example block diagram of a deployment of a computer-implemented embodiment of the present technology comprising hardware, firmware, software or hybrid components;

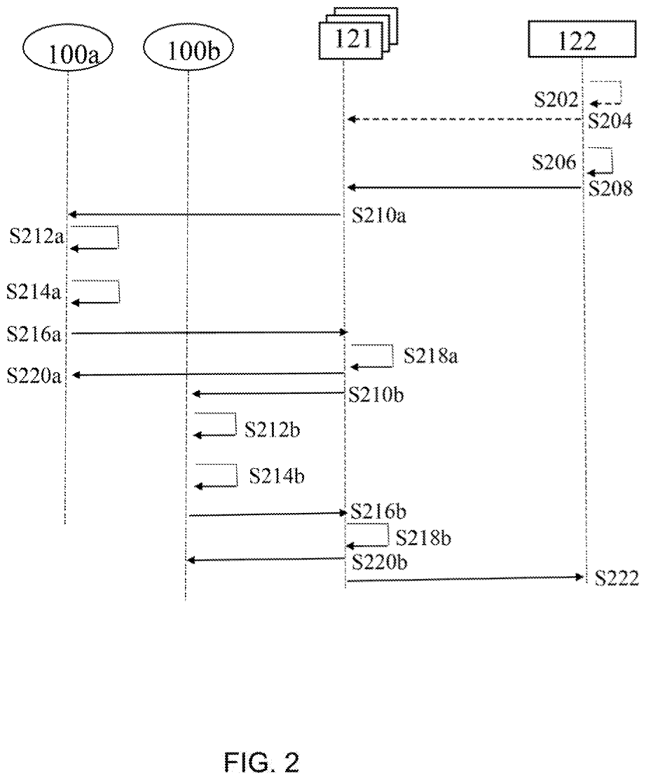

FIG. 2 shows an illustrative example of device obtaining a resource from a distributor;

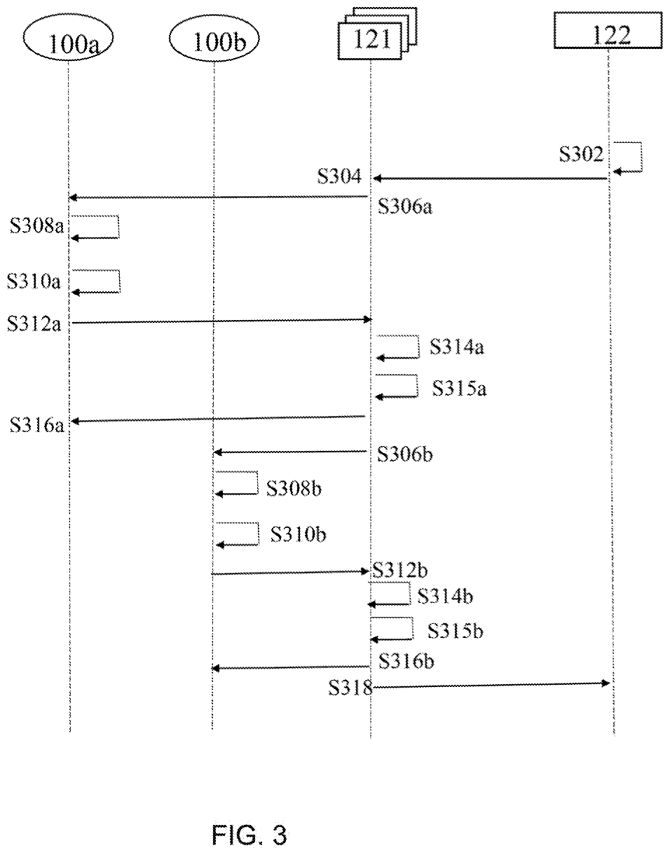

FIG. 3 shows a further illustrative example of device obtaining a resource from a distributor;

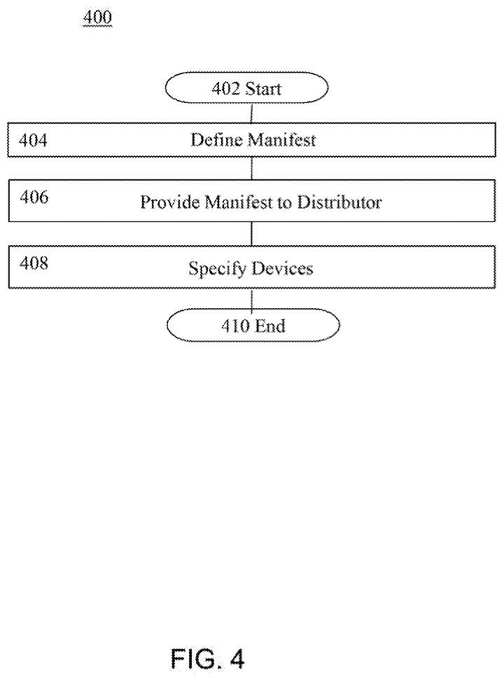

FIG. 4 shows an example of process of an author providing a manifest to a distributor;

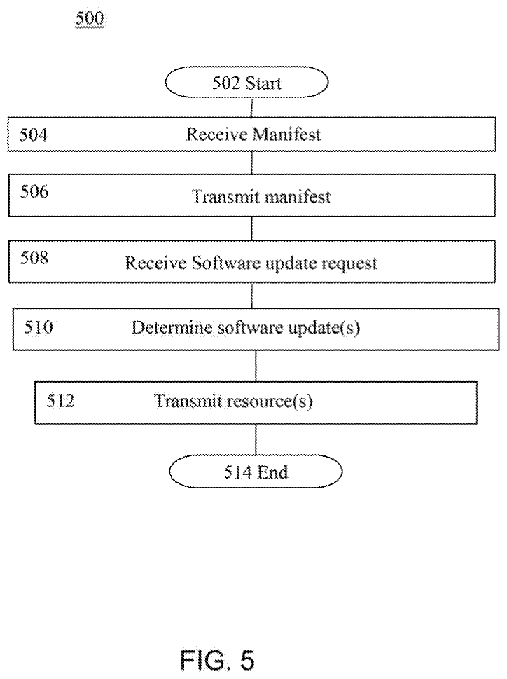

FIG. 5 shows an example of process of a distributor managing a software update campaign on one or more devices; and

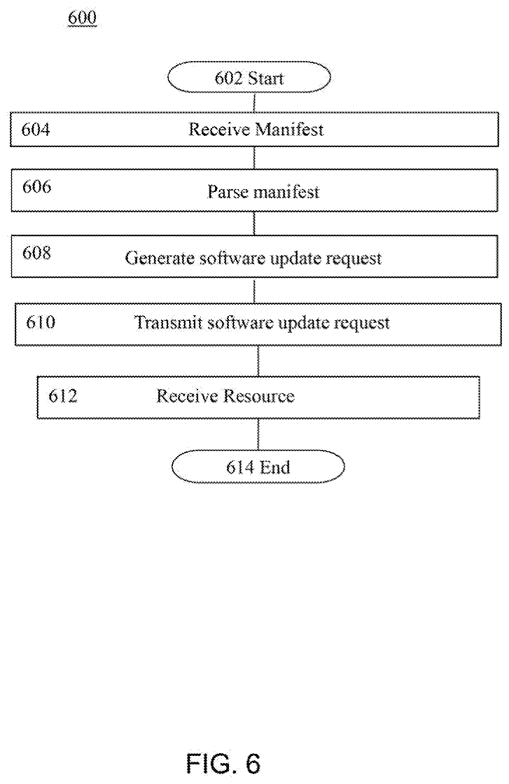

FIG. 6 shows an example of a process for a device obtaining a software update.

A device, such as an IoT device, may be provided with a resource in the form of a software update (e.g. applications, firmware etc.), whereby a full software image is transmitted to the device to enable the device to replace pre-existing software with the software image. Additionally, or alternatively, a delta software update (hereafter “delta update”) may be provisioned on the device. A delta update enables software updates by providing differential software update data (e.g. the difference between two software versions) to the device and may be accompanied with instructions on how the device is to generate the updated software version to be installed. The device can then use this delta update together with the pre-existing software to generate the updated software version for installation on the device. Although the device could be provisioned with a full software update to replace all of the pre-existing software rather than a delta update, a delta update may be smaller in comparison to a full software update replacing all of the pre-existing software and, therefore, the delta update may save both bandwidth of the network as well as storage and processing power of the device(s) and distributor(s) in comparison.

In an embodiment, distribution of a resource comprising the software update may be achieved by storing the software update at a network accessible location and sending to the device a software update manifest (hereafter “manifest”) comprising a resource request identifier corresponding to the location at which the device can request the resource. The resource request identifier may comprise any suitable identifier which is used to locate a resource such as a Uniform Resource Identifier (URI), Uniform Resource locator (URL), Uniform Resource Name (URN) etc.

The manifest comprises one or more blocks of data providing information about a resource. An author may encode information in the manifest in a format that can subsequently be decoded by the device (e.g. using a parser component thereon). In an illustrative example the information may be encoded using plaintext, Binary type-length-value (TLV), Concise Binary Object Representation (CBOR) or JavaScript Object Notation (JSON) although the claims are not limited in this respect. Additionally, or alternatively the information may comprise instructions for enabling the device to parse the manifest correctly. In examples the manifest may comprise byte code.

For security, the manifest may comprise a message authentication code (MAC) value in the manifest and/or the manifest may be cryptographically signed to enable the device to determine if the manifest can be trusted (e.g. by checking the MAC value/signature are as expected). Additionally, or alternatively, the manifest may be cryptographically encrypted such that only devices having a corresponding cryptographic key can decrypt the manifest. Such functionality means that when the manifest is taken to be trusted, the information therein can be taken to be authenticated. When the information cannot be authenticated the device can take an action such as discarding a manifest that cannot be trusted, logging the incident and/or reporting the incident (e.g. to the distributor or author). Such functionality also provides for end-to-end security between a device and the entity that generates the manifest (e.g. the author in the present illustrative example) because the entity that builds the manifest can have a level of confidence that no other party (including potential adversaries) can install software updates on devices without adequate privileges.

The manifest may also comprise cryptographic keys (e.g. symmetric or asymmetric keys) which may themselves be encrypted by a trusted authority. The device can decrypt the encrypted cryptographic keys and use the decrypted cryptographic keys to, for example, verify the signature or decrypt further encrypted data to determine whether the manifest can be trusted.

The manifest may also comprise information about the resource. For example, the manifest may specify a size of the expected software update so that the device does not write more data than required when it installs the software update.

The manifest may include a hash value or digest corresponding to the software update, whereby the device may verify that the digest of a subsequently received software update matches the digest in the manifest to check that the received software update is as expected.

The manifest may also comprise instructions for the device to obtain a resource. For example, the manifest may include a characteristic definition specifying one or more characteristics of the device to be identified by the device in a software update request. A characteristic of the device may include one or more of: a hardware configuration, a software configuration and a current state of the device. As an illustrative example, a characteristic of the device may include: a software version currently active on the device or active for a component of the device; the class of device or the class of a component(s) thereon; the vendor of the device or a component(s) thereon; the manufacturer of the device or a component(s) thereon; the current geographic location thereof; the security capabilities and/or requirements for the device or a component(s) thereon; the communications capabilities of the device or a component(s) thereof; a schedule specifying when the device (or a component thereon) is active or asleep. It will be appreciated that the list of characteristics is exemplary only.

The instructions in the manifest may define one or more fields of a software update request which the device is to populate, whereby the one or more fields be part of a template having a specific structure. In embodiments the manifest specifies how the device is to populate the one or more fields. Additionally, or alternatively, instructions provisioned on the device may specify how the device is to populate the one or more fields.

In an embodiment the device populates the defined one or more fields of the software update request with one or more characteristic values which correspond to one or more characteristics of the device.

For example, a characteristic value may correspond to a Class identifier (ID); Vendor ID; manufacturer ID; software version ID (of the device or component thereof). As a further example a characteristic value may correspond to geographical coordinates specifying the current geographic location of the device. As a further example a characteristic value may correspond to a software version identifier for a cryptographic application thereby specifying security capabilities for the device or a component(s) thereon. As a further example a characteristic value may comprise a hardware identifier for a communications module (e.g. Wi-Fi or Bluetooth) thereby specifying communications capabilities of the device. As a further example a characteristic value may correspond to a plurality of times specifying when the device (or a component thereon) is active or asleep.

An entity receiving the software update request (e.g. the distributor) can then determine the characteristics of the device based on or in response to the one or more characteristic values in the software update request. The entity may then determine which software update is required for the device based on or in response to the characteristics thereof.

A characteristic value may take any suitable form, and may comprise one or more characters such as, for example, numeric characters (e.g. integers, floating point, etc) and/or text characters (e.g. letters and symbols). For example, a characteristic value may be a string of such characters (e.g. as plaintext or an output of a hashing operation). In a further embodiment a characteristic value may comprise one or more bits in a bitmap, or a characteristic value may comprise one or more bit flags, set to ‘1’ or true when the device has a particular characteristic and set to ‘0’ or false when device does not have a particular characteristic.

The form of the characteristic values provided in the software update request will preferably be sufficient to enable a receiving entity to identify a correct software update for a particular characteristic value(s) while avoiding an accidental collision e.g. where two or more software updates are identified for the same characteristic value(s). As an illustrative example the characteristic value(s) may be, for example, a unique identifier such as a unique plaintext value, a Universally unique identifier (UUID), a globally unique identifier (GUID). In some embodiments the one or more characteristic values may be subject to a cryptographic operation to provide one or more digests which is/are included in the software update request as a unique identifier.

As described above, the present techniques enable an entity receiving a software update request from a particular device to determine the software presently active on a device and also determine what software updates should be provided to the device. The device may have multiple different components and thus may require software updates for each different component. As an illustrative example, a device has the following physical components: A host MCU and a Wi-Fi module and has three software components: an operating system; a Wi-Fi module interface driver and applications. The device may include any number of UUIDs as characteristic values corresponding to vendor IDs or class IDs for the physical or software components. For example, a device that has an operating system and one or more applications might include one Vendor ID for the OS and one or more additional Vendor IDs for the applications. This device might also include a Class ID for the OS and one or more Class IDs for the applications. The Wi-Fi module's firmware has a proprietary update mechanism and doesn't support manifest processing. This device can report four class IDs: hardware model/revision, OS, Wi-Fi module model/revision and an application. A distributor can then, using the characteristic values reported in the software update request determine the correct software update dependent on the characteristic values, and tailor the resource(s) provided to each device accordingly. This allows the OS, Wi-Fi module, and application software to be obtained by the device and updated independently of one another. This approach allows an entity (e.g. vendor, distributor, owner) to target, for example, all devices with a particular hardware or software component with a single manifest, which is a very powerful mechanism, particularly when used for security updates.

The distributor may also determine one or more capabilities of the device based on or in response to the information in the software update request. For example, when the characteristic value(s) in the software update request relates to a Bluetooth or Wi-Fi communications module the distributor can determine that the device has Bluetooth or Wi-Fi Communications modules, and provide updates for each of the different modules if required.

As a further illustrative example, when the characteristic value(s) in the software update request relate to a particular security module the distributor can determine that the device has particular security capabilities.

As a further illustrative example, when the characteristic value(s) relate to a sleep schedule for the device the distributor can determine when the device is awake or asleep. It will be appreciated that the device capabilities described herein are exemplary only and the claims are not limited in this respect.

The distributor can then provide the resource to the device based on or in response to the determined capabilities.

For example, when the device has certain communication capabilities the distributor can instruct only servers with those communication capabilities to provision the software update on the device. Such functionality means that servers that cannot communicate with a particular device will not be instructed to attempt to do so.

In a further example when the device has a certain sleep schedule the distributor will provision a software update on the device, or will instruct servers to provision the software update on the device when the device is scheduled to be awake. Such functionality means that the distributor or another server may only attempt to deliver the software update when the device is active, thereby minimizing unnecessary power/communication/processing expenditure by the distributor or other server(s).

In a further example when the device is located at a particular geographical location the distributor will have servers appropriate for that particular geographic location provision the software update on the device (e.g. servers in the same country/region as the device etc.). Such functionality means that a server closest to a particular device will deliver the software update to the device thereby minimizing latency.

Furthermore, the distributor can perform load balancing ensuring that a resource is transmitted to a device by a server that has capacity to do so or when that server has capacity to do so.

Thus, by actively managing transmission of the resources to different devices based on information in the software requests received from each of the devices, the distributor can manage the burden on the network(s) (e.g. processing, communications, bandwidth burden) and decrease latency for devices receiving the update.

Referring to FIG. 1, an example of a deployment of a computer-implemented embodiment of the present technology is shown.

Device 100 is shown in FIG. 1 as being networked with at least distributor 121 and author 122 but is also operational with numerous other general purpose or special purpose computing system environments or configurations. Examples of well-known computing processing systems, environments, and/or configurations that may be suitable for use with device 100 include, but are not limited to, gateways, routers, personal computer systems, server computer systems, thin clients, thick clients, hand-held or laptop devices, multiprocessor systems, microprocessor-based systems, set top boxes, programmable consumer electronics (smartphones, smart watches, tablets), network PCs, minicomputer systems, mainframe computer systems, and distributed computing environments that include any of the above systems or devices.

Device 100, distributor 121 and author 122 may be described in the general context of computer systems and computer systems on a chip (SoC). Such computer systems comprise executable instructions, such as program modules, being executed by a computer processor. Generally, program modules may include: routines; programs; objects; components; logic; and data structures that perform tasks or implement abstract data types.

Device 100 is connected through a network 120 to distributor 121 and author 122. Network 120 is depicted as a wide area network (WAN) in FIG. 1 but other types of network can be used including a low power wireless network. In one embodiment, network 120 may comprise a cloud computing environment. In embodiments the network may be a private network.

Device 100 comprises: processor 102; communication circuitry 104; and device memory 114.

Processor 102 is for loading machine instructions from device memory 114 and for performing machine operations in response to the machine instructions. Such machine operations include: performing an operation on a value in a register (for example arithmetical or logical operations); moving a value from a register to a memory location directly and vice versa; and conditional or non-conditional branching. A typical processor can perform many different machine operations. The machine instructions are written in a machine code language which is referred to as a low-level computer language. A computer program written in a high-level computer language (also known as source code) needs to be compiled to a machine code program (also known as object code) before it can be executed by the processor. Alternatively, a machine code program such as a virtual machine or an interpreter can interpret a high-level language (such as C) in terms of machine operations.

Communication circuitry 104 is for enabling communication between device 100 and other devices. The communication circuitry 104 may use wireless communication, such as communication using wireless local area network (Wi-Fi), short range communication such as radio frequency communication (RFID) or near field communication (NFC), or communications used in wireless technologies such as ZigBee, Thread, Bluetooth, Bluetooth LE, IPv6 over Low Power Wireless Standard (6LoWPAN) or Constrained Application Protocol (CoAP). Also, the communication circuitry 104 may use a cellular network such as 3G or 4G. The communication circuitry 104 may also use wired communication such as using a fibre optic or metal cable. The communication circuitry 104 could also use two or more different forms of communication, such as several of the examples given above in combination.

Processor 102 comprises: processing circuitry 112, which in turn comprises firmware 110; operating system 108; and processor memory 106.

Processing circuitry 112 is for processing instructions and comprises: fetch circuitry for fetching instructions; decode circuitry for decoding instructions; and execution circuitry for executing instructions (not shown). Data and program code stored in device memory 114 are accessible to processing circuitry 112.

Firmware 110 may comprise an operating kernel program for running one or more processes and environments. Firmware 110 can be embodied in circuitry or program instructions in processor memory 106.

Operating system 108 is a system for loading and executing program modules including device applications. Operating system 108 can be embodied in circuitry or program instructions in processor memory.

Processor memory 106 provides the execution environment for processor 102 and space for the program instructions for the firmware 110 and operating system 108.

Device 100 may have hardware/software components 115 having associated software (e.g. firmware) to enable the components 115 to function. Such components may comprise a radio module, camera, GPS module although the claims are not limited in this respect.

Author 122 and distributor 121 are similarly operational with numerous other general purpose or special purpose computing system environments or configurations and are typically servers, comprising computer components such as those described for device 100 but these are not shown nor described in any great detail. Such servers may be discrete entities or may comprise two or more distributed entities.

Author 122 is an entity trusted by device 100. Such trust may be established on the basis of cryptographic keys provisioned on the device 100 (e.g. during a bootstrap process) although the claims are not limited in this respect and MAC values or other trust anchors may be used to establish trust. The device 100 can verify signatures on communications to determine that the communications were signed by the author 122. Additionally, or alternatively, the device 100 can decrypt communications encrypted by the author 122. In embodiments the device 100 can sign/encrypt communications that can be verified/decrypted by the author 122.

Distributor 121 communicates with the device 100 (e.g. to transmit manifest(s)/receive software update request(s)) and to distribute a resource to the device 100 in response to a software update request.

The distributor 121 and device 100 may communicate via secure communications channel whereby communications are signed/encrypted, although in some embodiments the distributor 121 and device 100 may communicate via a non-secure communications channel.

The distributor 121 is depicted a single entity in FIG. 1, but the claims are not limited in this respect and a distributor that transmits manifests to the device 100 may be the same entity (e.g. a single server) or may be a different entity (e.g. two or more servers) to that which receives a software update request from the device 100.

Similarly, the distributor that distributes a resource to the device 100 in response to a software update request may be the same entity or may be a different entity to the distributor which receives the software update request and/or the distributor which transmits manifests to the device 100.

As will be immediately clear to one of ordinary skill in the art, the separations between components shown in the drawing are not to be taken to mean that other arrangements are excluded from consideration; in implementations of the present technology, components shown here as separate may be combined in higher-level components or implemented in varying physical and logical structures. In the present embodiments the device 100 is taken to be a constrained device (e.g. constrained bandwidth, power and/or processing etc.).

FIG. 2 shows an illustrative example of devices 100a and 110b obtaining a resource from distributor 121.

As an illustrative example devices 100a and 100b may be owned by author 121, whereby device 100a has version 1 (v1) of a firmware thereon and device 100b may have v2 of the firmware thereon. The author may want all devices which it owns to be updated to the latest software version and may engage distributor 121 to update the devices as part of an update campaign.

At S202 the author 122, which is trusted by devices 100a and 100b, generates a software update comprising firmware V3. The software update may replace the pre-existing firmware on devices 100a and 100b, or the software update may be a delta update. At S204 the author transmits the v3 firmware to the distributor 121.

At S206 the author defines a manifest to be distributed to the devices that are to be updated and signs the manifest, for example, using a private cryptographic key.

At S208 the author 122 transmits the manifest to the distributor 121. The author 122 also defines the devices which the distributor is to provision with the manifest (e.g. some or all of the devices owned by the author).

At S210a/b the distributor 121 transmits the manifest to the devices defined by the author (depicted as devices 100a/100b in FIG. 2 although any number of devices may be defined in practice). In embodiments the distributor may have a pre-existing relationship with the devices, whereby the devices may have registered with the distributor. Alternatively, the author may provide sufficient information to enable the distributor to establish a connection with each of the devices that are to be updated.

At S212a/212b the respective devices 100a/100b parse the manifest to obtain the instructions for obtaining the correct resource.

As described above, the device can determine whether or not the information in the manifest is authenticated and take an action such as discarding a manifest that cannot be trusted, logging the incident and/or reporting the incident (e.g. to the distributor or author) when not authenticated.

At S214a/b the respective devices 100a/100b generate a software update request in accordance with information in the manifest.

At S216a/b the respective devices 100a/100b transmit the software update request to a location corresponding to the resource request identifier (depicted as distributor 121 in FIG. 2).

At S218a/b, the distributor 121 parses the respective software update requests and determines the correct software update for each device. At S220a/b the distributor transmits a resource to the respective devices 100a/b.

In an embodiment the resource may comprise the software update to be installed by a device. In a further embodiment the resource may comprise information to enable the device to obtain the correct software update. For example, the resource may comprise a further location identifier for a further distributor from which the device will obtain the software update to be installed.

Although not depicted in FIG. 2, the devices 100a/b will install the software update when received. In some embodiments the devices 100a/b will verify the software update is the correct or expected software update as described in greater detail below.

At S222 the distributor 121 reports to the author that the software updates have been distributed.

In the Illustrative example of FIG. 2 the author is depicted as generating the software update but in other embodiments the distributor may generate the software update based on or in response to the software update request.

FIG. 3 shows a further illustrative example of device obtaining a resource from distributor 121.

At S302 the author defines a manifest to be distributed to the devices that are to be updated and authenticates the manifest, for example, using a private cryptographic key or MAC value.

At S304 the author 122 transmits the manifest to the distributor 121. The author 122 also defines the devices which the distributor is to provision with the manifests as part of an update campaign.

At S306a/b the distributor 121 transmits the manifest to the devices defined by the author (depicted as devices 100a/b in FIG. 3 although any number of devices may be defined in practice).

At S308a/b the respective devices 100a/b parse the manifest. In an illustrative example, parsing the manifest comprises obtaining the instructions for generating a software update request. As described above, the device can determine whether or not the information in the manifest is authenticated and take an action such as discarding a manifest that cannot be trusted, logging the incident and/or reporting the incident (e.g. to the distributor or author) when not authenticated.

At S310a/b the respective devices 100a/b generate a software update request in accordance with the information in the manifest.

At S312a/b the respective devices 100a/b transmit the software update request to a location corresponding to the resource request identifier (depicted as distributor 121 in FIG. 3).

At S314a/b, the distributor 121 parses the software update request and determines the correct software update for each device.

At S315a/b the distributor 121 obtains a software update based on or in response to the software update requests from the respective devices 100a/b. The software update may be a full software update to replace pre-existing firmware on devices 100a and 100b, or the software update may be a delta update.

In embodiments the distributor 121 obtains the software update(s) for a particular device by dynamically generating the software updates based on or in response to the software update request received from that device. Alternatively, the distributor 121 may obtain the software updates for a particular device by communicating with another source such as the author 122 to obtain the software updates based on or in response to the software update request received from that device.

At S316a/b, the distributor transmits a resource to the respective devices 100a/b.

In an embodiment the resource may comprise the software update to be installed by a device. In a further embodiment the resource may comprise information to enable the device to obtain the correct software update. For example, the resource may comprise a further location identifier for a further distributor from which the device will obtain the software update to be installed.

Although not depicted in FIG. 3, the devices 100a/b will install the software update when received. In some embodiments the devices 100a/b will verify the software update is the correct or expected software update.

At S318 the distributor 121 reports to the author that the software updates have been distributed.

FIG. 4 shows an example of process 400 of the author providing a manifest to a distributor.

An author may want to update the software on one or more devices as part of an update campaign, whereby the author may own or may manage the one or more devices.

At 402 the process starts.

At 404 the author defines a manifest to be distributed to the devices that are to be updated. The manifest defined by the author specifies information to enable devices generate a software update request. The manifest may also specify other information. The author may sign the manifest (e.g. using a cryptographic key) to enable a receiving device to verify that the manifest was generated by the author.

At 406 the author provides the manifest to a distributor which is to manage distribution of the software updates to the one or more devices. For example, the distributor may be part of a device management service with which the one or more devices are registered.

At 408 the author specifies the devices to be updated as part of the update campaign. For example, the author may specify unique identifiers for each of the devices, whereby the unique identifier may comprise a URL, URI, GUID, UUID etc. In other examples the author may specify that all devices having a certain device characteristic(s) are to be updated.

At 410, the process ends.

FIG. 5 shows an example of process 500 of a distributor managing a software update campaign on one or more devices.

At 502 the process starts.

At 504 the distributor receives, from an author, a manifest to be used as part of a software update campaign for one or more devices. In embodiments the one or more devices will have established a connection with the distributor, for example whereby each of the one or more devices performs a registration process with the distributor so as to exchange data (e.g. device identifier information such as GUID, UUID; cryptographic keys, etc). Following such a registration process the one or more devices can communicate with the distributor (e.g. using end-to-end security).

At 506 the distributor transmits the manifest to one or more devices as part of an update campaign.

At 508, the distributor receives a software update request from each of the one or more devices.

At 510, the distributor processes each software update request and determines the appropriate resource for each of the one or more devices. For example, the distributor may identify the current software version active on a particular device (or component) based on or in response to one or more characteristic values in the software update request and then determine which software update (if any) is required for that device.

At 512 the distributor transmits a resource to the one or more devices. In an embodiment the resource may comprise the software update for a particular device. In a further embodiment the resource may enable the particular device to access the correct software update whereby, for example, the resource may comprise a further location identifier for a further distributor from which the particular device will obtain the software update.

At 514 the process ends.

Although not depicted in FIG. 5, each device may send a status update to the distributor (e.g. confirming when the software update is installed or when there is an issue).

Furthermore, although not depicted in FIG. 5, the distributor may provide a status update (e.g. to the author) on the progress of the update campaign. For example, the distributor can confirm which of the one or more devices have received the manifest and/or software update and also provide an update as to which of the one or more devices are awaiting the manifest and/or the software update, or if any of the one or more devices have reported an issue with the software updates.

As above, the distributor may not necessarily be a single entity and may, for example, comprise two or more servers distributed across one or more networks.

As will be appreciated the software update requests are tailored for each of the devices from which they are received and it's possible for the distributor to select the correct resource for each device.

FIG. 6 shows an example of a process 600 for a device obtaining a software update.

At 602 the process starts.

At 604 the device receives a manifest (e.g. from a distributor).

At 606 the device parses the manifest to obtain instructions for generating a software update request and obtaining a resource request identifier.

As described above, the device can determine whether or not the information in the manifest is authenticated. The device may, for example, perform a cryptographic operation on the manifest or verify a MAC value in the received manifest to determine whether the manifest can be trusted. When the manifest is taken to be trusted, the information therein (e.g. the resource request identifier and definition identifying the one or more characteristics of the device) is taken to be authenticated. When the manifest cannot be trusted, the device can take an action such as discarding the manifest, logging the incident and/or reporting the incident (e.g. to the distributor or author).

At 608 the device generates a software update request based on or in response to information in the manifest.

At 610 the device transmits the software update request to a location corresponding to the resource request identifier.

The software update request may be transmitted using any suitable transfer protocol such as, for example, HTTP, CoAP, FTP etc. For example, using HTTP and CoAP the device could send the software update requests as POST or GET requests.

At 612 the device receives a resource. When the resource is a software update the device will update the existing software using the software update. When the resource is a location identifier, the device will obtain the software update from the location identifier. In embodiments the device may perform a cryptographic operation on the software update, to verify that the software update is to be trusted. Such a cryptographic operation may comprise verifying a signature applied to the software and/or decrypting the software update. When the device cannot verify that the software update is to be trusted then the device may discard or ignore the software update or request a new software update. Such functionality mitigates the risk of the device installing a software update from an unauthorized party.

The device may verify that the received software update is the correct or expected software update. For example, the device may verify that the software update was generated by a trusted source (e.g. the author) and received from a trusted source (e.g. the distributor). In a further example the device may verify that the received software update is the correct or expected software update after installation on the device by checking that by comparing a digest of the resulting software image to a hash value in the manifest. However, such functionality means that the software update may need to be installed prior to verification. On single-image devices, failing to authenticate the software update before performing an in-place update could be problematic. As an additional, or alternative, verification the device may therefore perform a dry-run of the software update in order to determine whether the result would match a hash digest in the manifest.

In a further embodiment the device may perform block-based verification of the received software update. A block verification technique is a technique whereby received blocks of data may be checked individually to ensure that they are, for example, authorized for use, before they are processed by the receiver. This offers a means of, for example, tamper-proofing the blocks of data of a software update or other download. Thus, for example, a block that is found to fail verification may be re-requested, without the need for a full repeat of the original download. In one embodiment, a block verification technique applied by a receiver may make use of a chained digest created using a chained digest technique and sent by the sender.

A chained digest technique is, at its simplest, a technique whereby a stream of data is divided into blocks and each block is processed in turn to append a value derived by applying a transformative function to another, neighbouring block before the output block is transmitted. The value may be referred to as a digest, a hash value or a check value). For example, block B may be processed to append a digest of block A, and block C to append a digest of block B and its appended digest of block A, and so on, in a chained manner, from one end of the stream to the other.

The chaining digest technique may be applied forwards or in reverse through a stream of data, according to the particular requirements of the use-case under consideration. This chaining digest technique thus establishes a form of continuous dependency among the blocks in the output stream. As will be clear to one of skill in the art, this description has been much simplified and leaves the treatment of the starting block undefined. In one implementation a random seed may be used for the starting block in place of a neighbour block digest, although other implementations will be apparent to one of skill in the art.

At 614 the process ends.

Although not depicted in FIG. 6, the device may provide a status update (e.g. to the distributor) on the progress of the software update. For example, the device can confirm when the software update is installed, and for example, provide a hash value for the updated software installed thereon.

In accordance with the present techniques a manifest comprising a single resource request identifier can be provided to two or more devices, such that each of the two or more devices can use information in the manifest to send a software update request to a distributor at the location corresponding to the resource request identifier and obtain a software update applicable to each device.

The present techniques mean that, rather than sending a manifest for each different software version, only one manifest is needed to update different software versions on two or more devices because the software update requests are tailored by the respective devices.

This approach allows an entity to target one or more devices or particular component(s) on the one or more devices with a software update specific for each of the one or more devices/component(s) thereon using a manifest having a single resource request identifier.

The present techniques also provide for provisioning resources on devices which may have different versions of active software, variations of the software and different hardware components (or variations thereof) from one another, whereby the distributor can determine the correct resource(s) required to be provisioned to each device based on or in response to the tailored software update requests.

The present techniques also reduce network bandwidth and processing power in service/device side when only one update campaign with a single manifest is required to update different devices, rather than several concurrent update campaigns with different manifests for each specific software update.

As above, the software update requests may be transmitted using any suitable transfer protocol. In embodiments intermediate devices (e.g. gateways; routers, servers etc.) may be located between the one or more devices and the distributor. Such intermediate devices may be used to pass requests from the one or more devices and the distributor. Thus, an intermediate device in the intermediate infrastructure receiving (directly or indirectly) a request destined for the distributor may parse the software update request and identify the appropriate resource for the device from which the software update request originated. The intermediate device may resolve the request by providing a resource satisfying the software update request to the device that generated the software update request. As an illustrative example, the intermediate device may have some or all of the device characteristics as the device from which the software update request originated. The intermediate device may already have received the corresponding software update (e.g. delta update). Such functionality reduces bandwidth in a network (e.g. a mesh network) as the software update request is not always passed all the way through to the destination distributor, rather an intermediate component can resolve the request.

The present techniques are applicable to constrained devices such as IoT devices. In an illustrative example the techniques are applicable to lightweight machine-to-machine (LwM2M) devices. Such LwM2M devices have various LwM2M resources, which can be read, written, executed and/or accessed by servers/services. As an illustrative example, a LwM2M resource may comprise a value (e.g. generated by circuitry on the device). A web application may, via LwM2M server, request the value from the LwM2M device (e.g. with a REPORT request), whereby the requested value is read and reported back to the web application by the LwM2M server.

The LwM2M resources may be further logically organized into objects, whereby each LwM2M device can have any number of LwM2M resources, each of which is associated with a respective object. A set of objects on LwM2M device may include, for example: ‘security object’ to handle security aspects between the LwM2M device and one or more servers; a ‘server object’ to define data and functions related to a server; an ‘access control object’ to define for each of one or more permitted servers the access rights the one or more servers have for each object on the LwM2M device; a ‘device object’ to detail resources on the LwM2M device. A ‘connectivity monitoring object’ to group together resources on the LwM2M device that assist in monitoring the status of a network connection; A ‘firmware update object’ enables management of firmware which is to be updated, whereby the object includes installing firmware, updating firmware, and performing actions after updating firmware. A ‘location object’ to group those resources that provide information about the current location of the LwM2M device; A ‘connection statistics object’ to group together resources on the LwM2M device that hold statistical information about an existing network connection.

In embodiments LwM2M device may have one or more instances of an object. As an illustrative example, a temperature sensor device may comprise two or more temperature sensors, and the LwM2M device may comprise a different device object instance for each temperature sensor. In embodiments a LwM2M resource may also comprise one or more LwM2M resource instances. The objects, object instances, LwM2M resources and LwM2M resource instances may be organized in an object hierarchy where each of the objects, object instances, LwM2M resources and/or LwM2M resource instances are elements of the object hierarchy, and whereby the device can enumerate the different elements of an object instance hierarchy using one or more characteristic values (e.g. using a URL; URN etc.).

Thus, a characteristic value(s) in a software update request generated by a LwM2M device may comprise one or more elements of the object hierarchy of the LwM2M device, and a receiving entity (e.g. a LwM2M server) can determine software updates to be provisioned to the LwM2M device.

As will be appreciated by one skilled in the art, the present techniques may be embodied as a system, method or computer program product. Accordingly, the present technique may take the form of an entirely hardware embodiment, an entirely software embodiment, or an embodiment combining software and hardware. Where the word “component” is used, it will be understood by one of ordinary skill in the art to refer to any portion of any of the above embodiments.

Furthermore, the present technique may take the form of a computer program product tangibly embodied in a non-transient computer readable medium having computer readable program code embodied thereon. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction-set to high-level compiled or interpreted language constructs.

It will also be clear to one of skill in the art that all or part of a logical method according to embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored using fixed carrier media.

In one alternative, an embodiment of the present techniques may be realized in the form of a computer implemented method of deploying a service comprising steps of deploying computer program code operable to, when deployed into a computer infrastructure or network and executed thereon, cause the computer system or network to perform all the steps of the method.

In a further alternative, an embodiment of the present technique may be realized in the form of a data carrier having functional data thereon, the functional data comprising functional computer data structures to, when loaded into a computer system or network and operated upon thereby, enable the computer system to perform all the steps of the method.

It will be clear to one skilled in the art that many improvements and modifications can be made to the foregoing exemplary embodiments without departing from the scope of the present disclosure.

1. A machine-implemented method for updating software on a device, the method performed at the device comprising:
receiving a software update manifest comprising an authenticated resource request identifier and an authenticated definition identifying one or more characteristics of the device;
generating a software update request comprising a value for each of the one or more identified characteristics of the device;
transmitting, to a location corresponding to the resource request identifier, the built software update request;
receiving a resource enabling access to or including a software update appropriate for the one or more values of the one or more identified characteristics; and
updating the software of the device in accordance with the software update.

2. The method of claim 1, further comprising:
parsing the manifest to derive one or more instructions for generating the software update request.

3. The method of claim 1, wherein the one more characteristics of the device relate to one or more of: a hardware configuration and software configuration and a state of the device.

4. The method of claim, 1 wherein the value for each of the one or more identified characteristics of the device comprises a unique identifier.

5. The method of claim 1, wherein receiving the software update manifest comprises receiving the software update manifest from a first server.

6. The method of claim 5, wherein the location corresponding to the resource request identifier comprises the first server.

7. The method of claim 6, wherein receiving the resource comprises receiving the resource from the first server.

8. The method of claim 5, wherein receiving the resource comprises receiving the resource from an intermediate component between the device and the first server.

9. The method of claim 1, wherein the location corresponding to the resource request identifier comprises a second server.

10. The method of claim 9, wherein receiving the resource comprises receiving the resource from the second server.

11. The method of claim 1, wherein the resource enabling access to the software payload comprises a location identifier.

12. The method of claim 1, wherein updating the software on the device comprises replacing all of the active software with the software update.

13. The method of claim 1, wherein the software update comprises a delta update.

14. The method of claim 1, further comprising one or more of:
verifying that the manifest is trusted and verifying that the resource is trusted.

15-16. (canceled)

17. A machine-implemented method for provisioning a software update on a device, the method performed at a server comprising:
sending, from the server to the device, a software update manifest comprising an authenticated resource request identifier and an authenticated definition identifying one or more characteristics of the device;
receiving, at the server from the device, a software update request;
sending, from the server to the device, a resource based on or in response to the software update request, wherein the resource is to enable the device to access the software update or wherein the resource includes the software update.

18. The method of claim 17, wherein the resource is appropriate for one or more characteristics of the device identified in the software update request.

19. The method of claim 17, further comprising: actively managing sending the resource based on information in the software requests.

20. The method of claim 17, further comprising:
receiving, at the server, the software update; or
generating, at the server, the software update.

21. The method of claim 17, further comprising: actively managing sending the resource based on information in the software requests.

22. A machine-implemented method for provisioning a software update from a first device to a second device, the method performed at the first device comprising:
receiving, at the first device, a software update request generated by a second device and destined for a server;
parsing, at the first device, the software update request;
sending, from the first device to the second device, a resource based on or in response to the software update request when the resource is available, wherein the resource is to enable the device to access the software update or wherein the resource includes the software update; or
forwarding, from the first device to the server, the software update request when the resource is not available to the second device.

23-25. (canceled)
